(19) United States
(12) Patent Application Publication
(10) Pub. No.: US 2017/0094460 A1
(43) Pub. Date: Mar. 30, 2017

(54) Mobile Communications Devices

(71) Applicant: NABLE-IT LIMITED, Chippenham Wilts (GB)

(72) Inventors: Peter Warren, Weston Super Mare (GB); John Palmer, Chippenham (GB); Dean Warren, Bristol (GB)

(21) Appl. No.: 15/249,056

(22) Filed: Aug. 26, 2016

(30) Foreign Application Priority Data
Aug. 26, 2015 (GB) GB 1515145.9
Jun. 30, 2016 (GB) GB 1611480.3

(51) Int. Cl. H04W 4/02; H04W 64/00; H04W 4/04

(52) U.S. Cl. CPC H04W 4/021; H04W 4/023; H04W 4/043; H04W 64/006

(57) ABSTRACT

An apparatus for communicating with wireless devices is described. The apparatus in one form includes a shrouded antenna arrangement (700) which is arranged to produce a radiated field forming a pre-determined detection zone having a boundary, spaced apart from the arrangement. Outside of the boundary the energy of the radiated field is below a pre-determined cut-off threshold. The shrouded antenna arrangement (700) in one form comprises an antenna (705) within an RFAM shroud (710). The RFAM shroud (710) may then have an absorption profile that varies around the antenna to form the detection zone.

### TECHNICAL FIELD

The present invention relates to locating and communicating with mobile communications devices.

### BACKGROUND

It is known to be possible to locate wireless mobile communications devices (or simply ‘wireless devices’) by receiving signals emanating from such devices. When a signal is received, it may contain data identifying the device that transmitted the signal, and the broad location of the device may then be determined to be within a generally defined geographic area. Wireless devices may be mobile telephones, tablets or any other kind of mobile, portable or, indeed, movable device that is capable of communicating, for example, using any one or more known, standard communications protocols, such as 2G, 3G, LTE, NFC, Bluetooth, Wi-Fi, WiMAX, or any other known or future, for example, cellular, point-to-point or peer-to-peer communications protocol.

WO2006/010774 describes a way of monitoring the movement of people carrying mobile devices within a specific area, by monitoring for and receiving signals emanating from such devices. The approach detects unique identifiers such as MAC addresses, for example, transmitted on a control channel of the wireless devices. Receipt of the signals by plural receivers that are spaced apart within the specific area enables the location of the wireless devices to be determined by using triangulation. This can be achieved without the person or wireless device having any additional location equipment or capabilities, such as a GPS receiver. The technique is said to be useful for identifying shopper location in retail environments, such as a shopping centre, in order to reveal which shops they visit.

While triangulation, and indeed trilateration and other similar methods, as such, are well-known location techniques, they have limitations, for example, when the transmitters and/or the receivers are located in built-up or generally ‘obstructed’ environments, which may lead to signals being reflected, attenuated or blocked. Obstructions may be walls, shelves between isles or other fixed or movable objects, or people, within any given environment, which may be partially or fully radio frequency (RF) signal reflecting and/or RF signal absorbing. Such obstructions can lead to unpredictable signal reflections (for example, causing multipath reflected signals) and/or attenuation of signals. Reflected signals in particular can lead to inaccurate location determinations, as the distance and time-of-flight from transmitter to receiver of a reflected signal is typically longer than that of a signal that is transmitted directly in free space (that is, without reflection) between a transmitter and a receiver.

Shopping centres are perceived to be one example of a built-up and generally obstructed environment, in which the aforementioned location techniques may not always provide a reliable way to track accurately the location and/or movement of a mobile device (and the respective user).

### SUMMARY

According to a first aspect of the present invention, apparatus is provided for communicating with wireless devices, the apparatus including a shrouded antenna arrangement which is arranged to produce a radiated field forming a pre-determined detection zone having a boundary, spaced apart from the arrangement, outside of which the energy of the radiated field is below a pre-determined cut-off threshold, the shrouded antenna arrangement comprising an antenna within an RFAM shroud, the RFAM shroud having an absorption profile that varies around the antenna to form the detection zone.

According to a second aspect of the present invention there is provided a system comprising an aforementioned apparatus, a processor to determine from a received signal an identity of a wireless mobile device that communicated the signal, and storage for storing a record of receipt of the signal from a wireless device that is identified by the respective identity.

According to a third aspect there is provided a beacon apparatus comprising an aforementioned apparatus.

According to a fourth aspect there is provided a method comprising arranging at least one aforementioned apparatus within an operating environment.

According to a fifth aspect there is provided a method of tracking a location and/or direction of movement of a wireless mobile device, the method comprising use of an aforementioned apparatus.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a schematic diagram of a wireless mobile device and two antennas arranged to perform location determination of the wireless device in an unobstructed environment;

FIG. 2 is a schematic diagram of a wireless mobile device and two antennas arranged to perform location determination of the wireless device in an obstructed environment; FIG. 3 is a schematic diagram of an exemplary obstructed environment in which plural antenna and mobile device locations are depicted for the purposes of wireless mobile device location determination;

FIG. 4 is a flow diagram of an exemplary process for performing location determination of a wireless mobile device;

FIGS. 5a to 5d are schematic diagrams of views of an exemplary shrouded antenna arrangement;

FIGS. 6a and 6b are schematic diagrams of exemplary wireless mobile device detection zones that may be formed by the exemplary shrouded antenna arrangement of FIGS. 5a to 5d;

FIG. 7 is a schematic diagram of a section through an exemplary shrouded antenna arrangement of the kind that is illustrated in FIGS. 5a to 5d, and illustrates exemplary field strength in the form of wave fronts flowing within and through the arrangement;

FIG. 8 is a flow diagram of an exemplary process for communicating signals to a wireless mobile device that is within a detection zone within a retail environment;

FIG. 9 is a schematic diagram of an exemplary system arranged to perform the process of FIG. 8;

FIGS. 10a to 10d schematic diagrams are examples of some alternative profiles of exemplary shrouded antenna arrangement of the kind that is depicted in FIGS. 5a to 5d; and

FIG. 11 is a schematic block diagram of an exemplary antenna arrangement that may be deployed in an obstructed environment.

### DETAILED DESCRIPTION

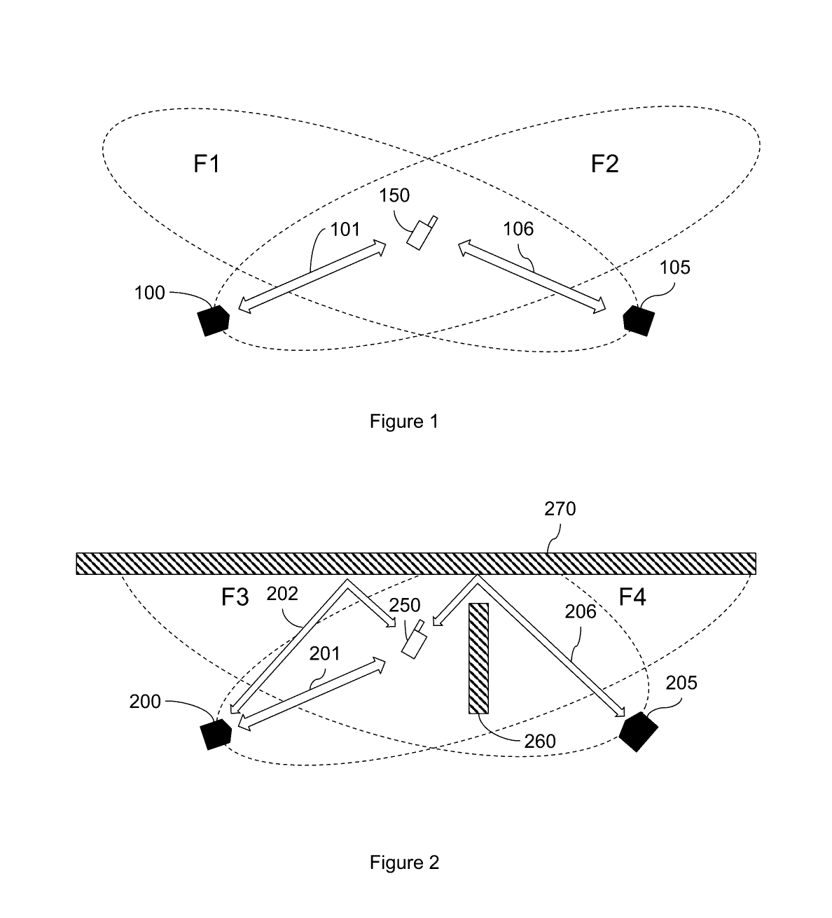

With reference to FIG. 1 and by way of further background, a plan view of a scene depicts first and second antennas 100 and 105, for example associated with respective wireless access points, which are shown to have relatively directional radiated fields, respectively, F1 and F2, and emit respective signals 101 and 106 (which are, for simplicity, depicted as arrows), including in directions towards a person carrying a wireless mobile device 150 (just the mobile device is shown for reasons of simplicity only). The mobile device 150 is within the range of the radiated fields, F1 and F2, of each antenna and so is able to receive signals. There are no obstructions between the antennas 100, 105 and the mobile device 150 and so communications can be direct, free space and line-of-sight. In this situation, the use of known techniques such as triangulation may be used to determine relatively accurately the location of the mobile device 150 relative to the known locations of the access points.

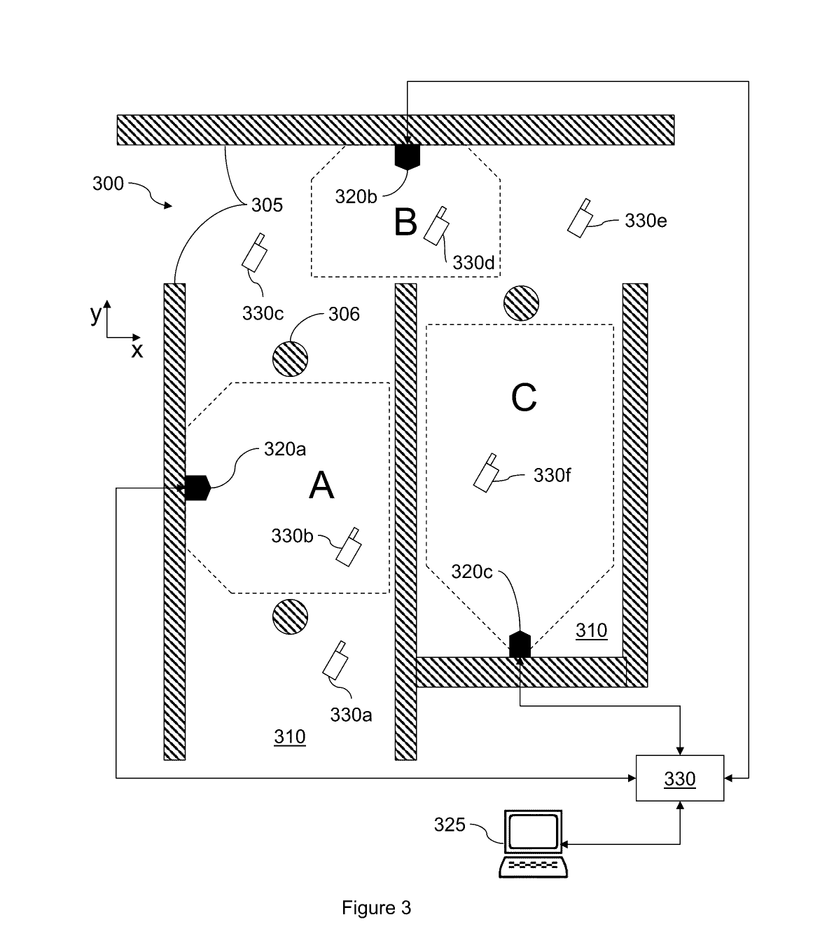

According to FIG. 2, similarly, a plan view of a scene depicts two antennas 200 and 205 and a mobile device 250. However, in this instance, the environment includes an obstruction 260, such as a wall or shelving between aisles in a shop, which restricts the range of respective radiated fields, F3 and F4. While the first antenna 200 has a line-of-sight with the mobile device 250, communications between the second antenna 205 and the mobile device 250 are likely to be either facilitated by reflected signals (for example, a signal 206 reflected from another wall 270, a ceiling or other RF reflective surface and/or attenuated signals). More generally, communications between antennas and mobile devices in obstructed environments are most likely to be facilitated by signals that are reflected multiple times and, indeed, multiple instances of the same signal may be received at slightly different times due to multipath propagation. For example, signals from the first antenna 200 may also reach the mobile device 250 via a signal 202 reflected from the wall 270. In such instances, therefore, while triangulation calculations and similar may still be performed, the results are unlikely to generate an accurate location of a mobile device, as there is no simple way to determine an accurate distance between an antenna and a mobile device.

The scenarios illustrated in FIGS. 1 and 2 apply equally to trilateration, which relies on determining accurately the distance of a mobile device from an antenna by measuring signal power and determining a Received Signal Strength Indicator (RSSI). Broadly-speaking the distance between a mobile device and an antenna is determined to be closer if the RSSI is higher and further away if the RSSI is lower. Again, a location of a mobile device can be determined by using two or more antennas, appropriate calibration for use of RSSI and a technique such as trilateration. However, once again, while such an approach can be useful in unobstructed environments, reflected signals and signals that have, for example, partially transmitted through obstructions can deliver a false power reading representing something other than an equivalent of a line-of-sight distance. An accurate location based on such an approach is therefore difficult to attain in an obstructed environment.

Of course, in real obstructed environments, there are likely to be many obstructions (for example, walls or shelving between aisles in a shop), many causes of signal reflections (for example, walls, shelves, floors, ceilings, products on shelves, people, etc.) and many causes of signals having a reduced power (for example, due to partial transmission through certain mediums or objects). With this in mind it will be apparent that systems of the kind that are described in WO2006/010774 may not be ideally suited for determining accurate mobile device locations in an obstructed environment.

Embodiments herein provide an antenna arrangement which generates a well-defined and typically constrained RF pattern, which will be referred to herein as a ‘detection zone’. Such a detection zone comprises a three-dimensional, physical volume or space that is illuminated with (or filled by) a radiating field emitted by the antenna arrangement, whereby a mobile device can receive signals from the antenna arrangement while within the detection zone. Detection zones may be, physically, relatively small and have well-defined boundaries that are tailored to match and/or fit within a designated space or region, to just ‘touch’ the boundaries of the space or region so as not to produce measurable reflected signals. Outside of the detection zone, signals from the antenna arrangement are attenuated to below a determined cut-off power. In effect, the edges of a detection zone are made up of contours that follow sensitivity floor cut-off points of mobile devices, such that mobile devices cannot detect signals when located beyond the edges but can as soon as they cross the edge or boundary, at which point the field strength within the detection zone is above the sensitivity floor cut-off for the mobile device. Thus, mobile devices outside a detection zone will not detect any broadcast message. Only mobile devices within a detection zone will detect a broadcast message. The coverage and range of the detection zone may be constrained with respect to an operating environment so as to minimise or eliminate undesirable reflected RF signals that would otherwise be caused by obstructions. Any reflected RF signals that arise typically have a power below a cut-off power and therefore will not interfere with mobile device location determination. The cut-off power is determined to be below a typical operating sensitivity of a normal wireless device.

In contrast, off-the-shelf wireless access point devices, for example Bluetooth or Wi-Fi products, are typically designed to be generally omnidirectional and with a maximum coverage and range for a given RF power in order to maximise wireless connectivity. As will be explained herein, such devices do not generate a well-defined and constrained detection zone. Indeed, in use the radiated field patterns of such devices tend to be complex and unpredictable by design if obstructions are within the respective radiated fields, and such devices are therefore not well-suited to accurate location determination applications in such environments.

A detection zone according to embodiments herein is controlled to be directional and relatively small, for example having a coverage and range (from the antenna arrangement) of less than 10 metres in any direction. Some embodiments have a range of less than five metres or less than three metres. Other embodiments have a range of less than one metre. As will be described, the size and shape of a detection zone can be adapted for (or matched to) any particular operating environment, for example, such as relatively unobstructed regions within an otherwise obstructed operating environment, so that a relatively accurate determination of the location of a mobile device can be made. Detection zone shapes may be controlled to be generally square, rectangular, tubular, wedge-shaped, hemispherical, etc. to match a respective operating environment.

The diagram in FIG. 3 illustrates a plan view of an obstructed operating environment 300 comprising various obstructions, including, for example, walls 305 and pillars 306 in, for example, a retail environment. The walls 305 may for instance bound the environment or sit between aisles 310.

Also illustrated are three location sensors 320a, 320b and 320c, each comprising an antenna arrangement providing a respective detection zone A, B or C, which in turn corresponds with a respective unobstructed region within an obstructed operating environment 300. The coverage and range of each detection zone is generally depicted, in two dimensions (x, y), by a respective dashed boundary line; and it will be appreciated that, in practice (in this and in other examples herein), the detection zones have a height/depth dimension (z) as well, which typically extends from floor-level to a height, which may, for example, be restricted by a ceiling or constrained by the antenna arrangement itself. The detection zones may be constrained in each dimension (x, y, z), as the need dictates, to minimise or eliminate reflected signals and provide a relatively small and well-defined region, from above the floor and avoiding obstructions, within which mobile devices can receive emitted direct, line-of-sight and un-reflected signals from the location sensors. Each detection zone is shown to have a different coverage and range, each of which can be tuned as required, as will be described.

Each location sensor may embody an integrated wireless access point including an antenna arrangement and appropriate control circuitry and/or components.

Each location sensor may be arranged to communicate data relating to emitted and received signals between itself and a remote computing apparatus 325, such as a personal computer, for example, via a router 330 and wired (or wireless) local area network, or by any other appropriate means. The location sensors may be powered by the mains or battery powered.

According to FIG. 3, six mobile device locations are illustrated, 330a-330f. Of these locations, locations 330a, 330c and 330e are shown outside of any detection zone. In contrast, location 330b is shown to be within detection zone A, location 330d is shown to be within detection zone B and location 330f is shown to be within detection zone C.

Each location sensor 320a, 320b, 320c, is arranged to emit periodically (for example ten times per second) polling information, via a polling signal, including an identifier, which is capable of uniquely identifying within the operating environment 300 the respective location sensor. Each location sensor is also arranged to listen for and receive return signals from mobile devices.

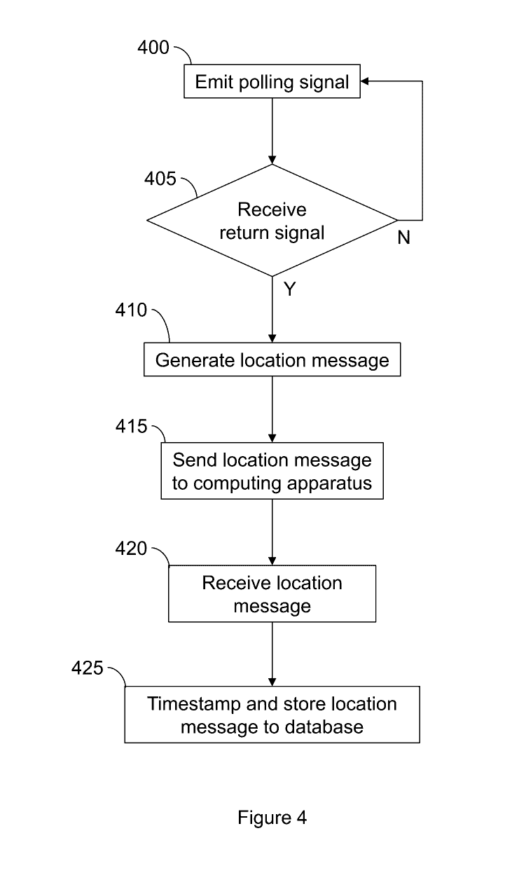

A first mode of operation of the system in FIG. 3 will now be described with reference to the flow diagram in FIG. 4.

In a first step 400, a location sensor 320a emits a polling signal (or a series of polling signals) for example including its identifier, and awaits receipt of a return signal in step 405 from a mobile device. The identifier may be an alphanumeric string comprising a number of characters that is sufficient to enable the locations sensors within a pre-determined environment (for example, a shopping centre) each to have a unique identifier. If a return signal, for example containing a copy of the identifier of the location sensor 320a and a unique identifier of a mobile device, is received, for example from a mobile device 330b, the location sensor 320a generates a location message including its identifier and the identifier of the mobile device 330b, in step 410, and communicates the message, in step 415, via the local area network, to the remote computing apparatus 325.

The remote computing apparatus 325 receives the message, in step 420, and, in step 425, registers the message, with a timestamp (which may either be generated by the computing apparatus 325 or received from the location sensor 320a) in a database (not shown), which is, for example, created and stored in a storage device of the computing apparatus or remotely from the computing apparatus.

In this way the presence of the mobile device 320a within zone A, at the time denoted by the timestamp, is captured. The location of the location sensor is known as is the form and location of detection zone A.

Over time, the database of time-stamped mobile device locations is increasingly populated and may be inspected to determine certain behaviours. From the collected data it is possible to establish various kinds of information and trends, including, for example, the time users spend in various detection zones and the paths users follow and the speeds with which they move around an operating environment. Because the detection zones are constrained and relatively small, and cause minimal or no signal reflections, the presence of a mobile device within a detection zone is closely determinative of the physical location of the wireless device within the operating environment. Accordingly, increasingly accurate location determinations of a mobile device within an obstructed environment can be achieved by decreasing the size of a respective detection zone (or zones) within the obstructed environment.

The first mode of operation depends on mobile devices being configured to listen for and respond to polling signals that are emitted by the location sensors. The first mode can be referred to as a beacon or broadcast mode, in which location sensors repeatedly broadcasts their existence.

Other embodiments herein may operate in a second mode, in which a location sensor is in ‘discovery’ mode. In this second mode the location sensor issues discovery requests only within its detection zone. The operation is similar to that of the first mode. Accordingly, mobile devices that respond to a request will always be within the respective detection zone.

Further embodiments herein may operate in a third mode, in which mobile devices are in a ‘discovery’ mode. In this case, a location sensor may well receive discovery requests from mobile devices that may be up to 100 m away. However, due to the constricted range of the location sensor, its responses to such discovery requests will not be received by the mobile device unless or until it moves within the respective detection zone, at which point the associated discovery protocol can complete. Completion of the protocol requires a handshake by which the mobile device may notify its presence in the detection zone to the location sensor.

As used herein, RFAM is a material that has a characteristic of being able to absorb at least a certain waveband of radio frequency radiation. The material may be of a known kind and, for example, comprise a material such as a dense, flexible elastomeric magnetic absorbing material, for example, that is loaded with carbon or iron-based particles or similar, so that it can absorb a certain band of radio frequency radiation. The RFAM may in some instances be covered or coated, partially or fully, with a protective layer (or layers) to provide protection, for example, from atmospheric conditions and/or to protect any relatively delicate surfaces during use or mechanical handling. A protective coating may, for example, comprise a neutral resin or other appropriate material, which may be applied by painting, spraying or in any other appropriate way.

An antenna and electronics as used herein may comprise a packaged Bluetooth LE device, which can operate in any Class 1, 2 or 3, having an unrestricted range of between 1 and 100 m and an operating frequency of 2.4 GHz. More generally, embodiments may use Bluetooth devices according to the closest form of a required detection zone, as follows;

ISM 13 cm Band: c2.4 GHz—Bluetooth 4 (with Suitable Bluetooth Device)

| | Maximum | | | |
|---|---|---|---|---|
| Power | Output Power | Range | Minimum Output | Electronic Power |
| Class | (Pmax) | (m) | Power (Pmin) | Control |
| 1 | 100 mW (20 | 100 | 1 mW (0 dBm) | Pmin <+ 4 dBm to |
| | dBm) | | | pMax |
| 2 | 2.5 mW (4 | 10 | 0.25 mW (−6 | Pmin to Pmax |
| | dBm) | | dBm) | |
| 3 | 1 mW (0 dBm) | 1 | N/A | Pmin to Pmax |

Class 2 Bluetooth devices are suitable for most applications in which a detection zone has dimensions less than 10m in any direction, with the antenna arrangement being configured to limit the coverage and range according to need, as described herein.

Alternatively, embodiments may deploy WiFi, as follows:

ISM 802.11/WiFi 13 CM Band: 2.4 GHz (with suitable WiFi devices)

ISM 802.11/WiFi 5 CM Band: 5.8 GHz (with suitable WiFi devices)

These and other known or to-be-developed standards may be deployed by embodiments.

Relative to known kinds of antenna arrangement that are typically associated with Bluetooth and Wi-Fi hot spots, the radiated field that forms the detection zone has a well-defined shape, relatively sharp edges and a constrained range, in a generally regular form.

A normal antenna arrangement typically delivers a beam pattern which has a main or front lobe and possibly side and back lobes. The main lobe is usually the one that is desired, whereas side and back lobes are often considered to be undesirable artefacts resulting from a complex function of constructive and destructive interference between emitted signal components. The lobes themselves are signal maxima resulting from constructive interference between wave elements while the nulls (that is, low or zero signal regions between lobes) are signal minima resulting from destructive interference between wave elements. The form of the lobes is at least in part determined within the near-field of the antenna, which is typically expressed as the field within a distance of one wavelength from the antenna. At a normal operating frequency of, say, 2.4 GHZ, the wavelength is in the region of 0.125 m. The near field is often found to be chaotic and is difficult to model. The near field develops spatially into the far field (beyond one wavelength from the antenna), where the field complexity reduces as many near field phenomena resolve. However, the far field is a product of the near field and has its own complexities, which may be exacerbated by reflections and transmission losses, which invariably influence the form of the RF beam pattern.

In contrast with normal antenna arrangements, a shrouded antenna arrangement according to embodiments of the invention aims to simplify the form of a radiated field in a number of ways, so that the coverage and range of the radiated field can be determined predictably and/or controlled. For instance, substantially only the wave fronts that are emitted from the antenna in an intended direction and/or towards a profiled area of RFAM can pass out of the shroud. Wave fronts that are emitted in any other direction (that is, for example not in the intended direction of the profile) are attenuated by RFAM as required to form the detection zone. The nature of the RFAM is such that wave front reflections are minimised or avoided completely. A result is that the wave fronts that pass out of the shroud are substantially limited to direct wave fronts and do not include reflected wave fronts. This greatly simplifies the emitted radiated field (due to its lacking reflected components) and means that the coverage and range of the radiated field are influenced significantly more by the absorption profile of the RFAM than by, for example, near-field chaos and/or constructive and/or destructive interference, which may be a factor with other arrangements in which reflected wave fronts (constructively or destructively) contribute to an overall emitted signal. Other factors that influence the radiated field, and can be varied and tuned as necessary to control the coverage and range thereof, include the kind of antenna used (and its respective unconstrained field pattern), the placement position of the antenna within the shroud, for example, and the orientation of the antenna relative to the shroud. If further range is required over and above that which is available from the sensor system, gain may be introduced into the system, for example, by introducing a parabolic dish, or similar reflector, behind the antenna, which may be repositioned so that the antenna is at the focal point of the dish or reflector.

Another way in which shrouded antenna arrangements according to embodiments of the invention may influence the coverage and range of the detection zone is through modifying the RF absorption profile of the RFAM in the intended direction. A thickness profile of the RFAM, or, more broadly, the profile of the degree of absorption thereof (which may for example be related to thickness and/or density and/or other blocking characteristics), constrains or attenuates the radiated field and, in turn, controls the range of the radiated field. In operation, the range is determined so that, within an obstructed environment, the power of the radiated field drops to below a determined threshold level, or RF cut-off point, at or near an obstruction. In this way, any element of the field that is reflected will be below the threshold level and will not therefore interfere with or indeed influence the ‘useful’ regions of the detection zone.

A suitable antenna for use in a shrouded antenna arrangement according to embodiments of the present invention is a known kind of arrangement comprising a meandering printed antenna, similar to a monopole antenna, which in this non-limiting example is mounted on a substrate without a ground plane directly beneath it. Other kinds of know antenna may be used instead, with parameters tuned for the present requirements.

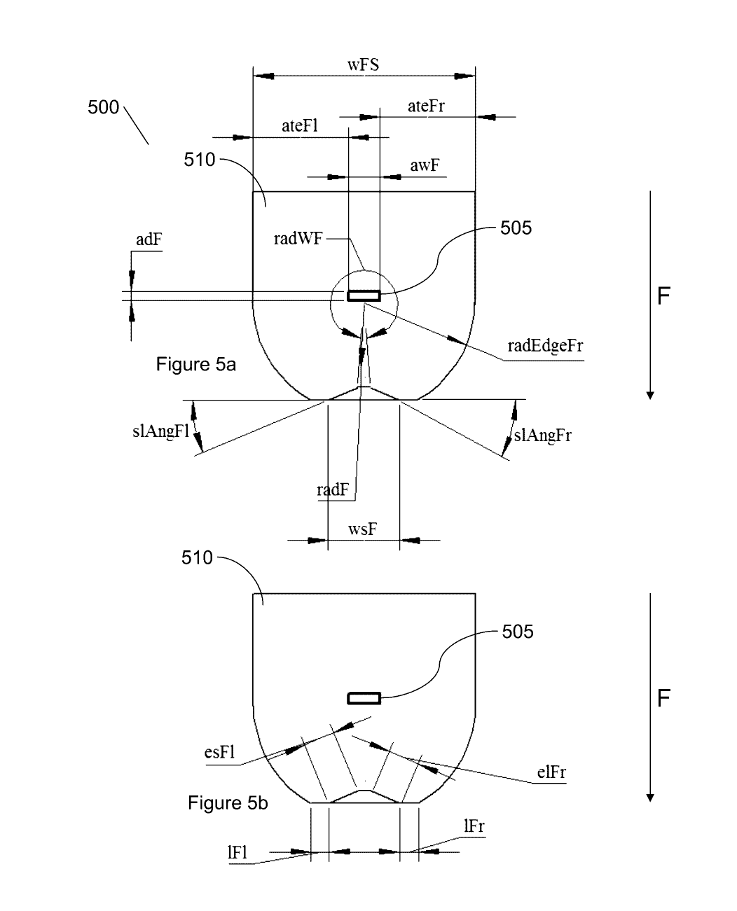

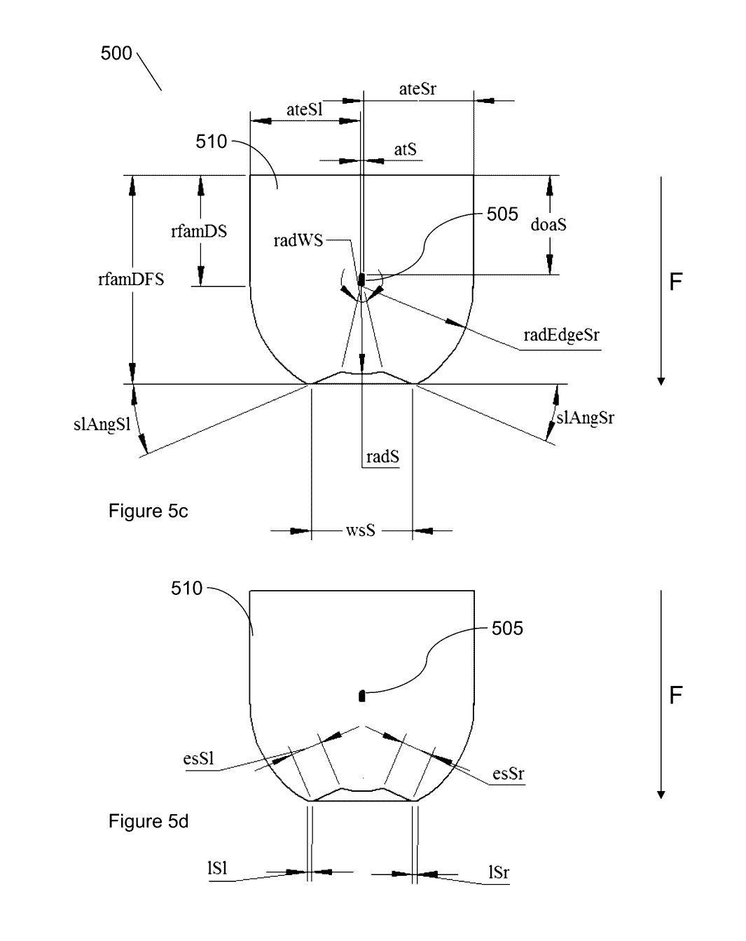

FIGS. 5a-5d are schematic views including dimensions of an alternative shrouded antenna arrangement 500 according to an embodiment of the present invention. The shrouded antenna arrangement 500 of FIGS. 5a and 5b can be arranged as a location sensor according to embodiments herein.

FIGS. 5a and 5b are a front elevation and FIGS. 5c and 5d are a side elevation of the antenna arrangement. An antenna 505 is in this example buried within a shroud 510, which is constructed of RFAM. In this instance, the degree of absorption and/or attenuation of the RFAM varies around the antenna, so that absorption and/or attenuation is lower in a forward direction F and higher in all other directions. In this example, the RFAM surrounding the antenna 505 has an RF absorption that is determined by the thickness and attenuation properties of the RFAM. In other embodiments the degree of absorption may be varied in other ways, for example by varying the density of the RFAM material or material types. In any event, the profile of the RFAM surrounding the antenna is such that substantially only signals emitted in a forwards direction F are able to pass through the RFAM. FIGS. 5a-5d may include electronics for driving the antenna and communicating with a remote computing apparatus, although such electronics are not illustrated for reasons of simplicity only.

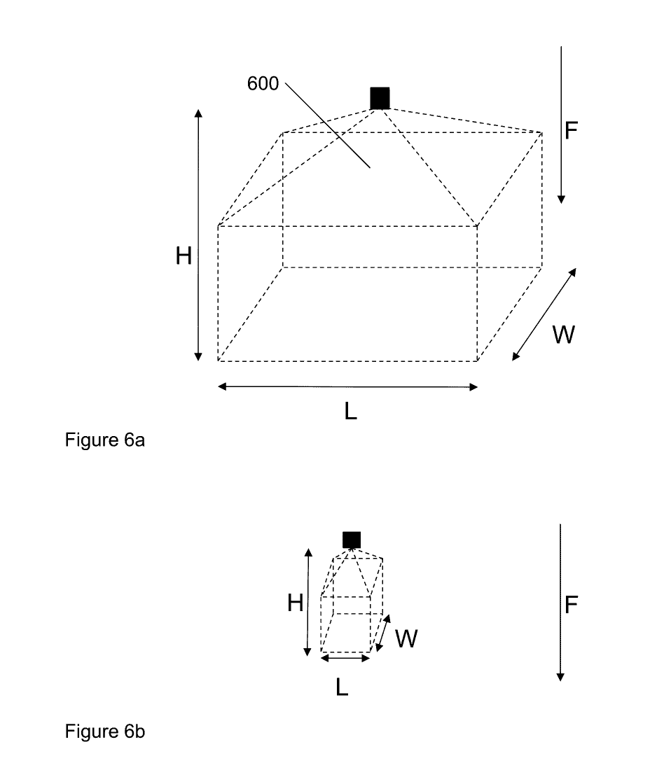

This example of a shrouded antenna arrangement is found to be quite sensitive to changes in shroud dimensions. Each value in the following tables is in relation to the desired RF pattern and desired sensor receiver sensitivity. The definitions and descriptions for each dimension in the following tables produce a detection zone as illustrated in FIG. 6a.

The dimensions of the shroud 510 are as follows:

Front Elevation (FIGS. 5a-5b)

| Label | Value | Description |
|---|---|---|
| wfS | 70 mm | Width of RFAM at base. In this example RFAM is circular so this is |
| | | a diameter. However it can be any shape. |
| ateFr | 30 mm | Antenna closest edge to RFAM outside edge on right hand side. |
| | | Antenna may not be placed uniformly in RFAM block. |
| ateFl | 30 mm | Antenna closest edge to RFAM outside edge on left hand side. |
| | | Antenna may not be placed uniformly in RFAM block. |
| awF | 10 mm | Width of antenna, in this example a printed meandering antenna on a |
| | | dielectric substrate, the dimension is to the furthest edge of the |
| | | antenna conductor material rather than the edge of the substrate. |
| | | However, the difference is negligible in this case. |
| radWF | 9° | Width of segment at radF |
| adF | 3 mm | Depth of antenna. The dimension is to the furthest edge of the |
| | | printed meandering antenna rather than the edge of the substrate. |
| | | However the difference is negligible in this case. |
| radEdgeFr | >=30 mm | Distance to edge of RFAM from closest point on the antenna to this |
| | | RFAM edge. Note antenna is 10 mm wide in this view. The |
| | | dimension is to the closest edge of the printed meandering antenna |
| | | not the edge of the substrate. However the difference is negligible in |
| | | this case. |
| slAngFl | 23° | Angle of slope from flat top right side. |
| slAngFr | 23° | Angle of slope from flat top left side. |
| radF | 26° | Depth of RFAM from closest edge of antenna conductor material to |
| | | centre of recessed circular area. |
| wsF | 22.5 | Overall width of slope plus centre area. |
| esFl | 10 mm | Length of edge sloping from flat top of RFAM to edge of centre |
| | | recessed flat area on left side. |
| esFr | 10 mm | Length of edge sloping from flat top of RFAM to edge of centre |
| | | recessed flat area on right side. |
| lFl | 6.5 mm | Length of flat area seen from the left. |
| lFr | 6.5 mm | Length of flat area seen from the right. |

Side Elevation (FIGS. 5c-5d)

| Label | Value | Description |
|---|---|---|
| wSS | 70 mm | Not shown on the drawing as it's not required for this example |
| | | because the width of RFAM at its base seen from the side view is the |
| | | same as from the base view as the RFAM is circular so this is a |
| | | diameter. However, in some applications this will be an irregular |
| | | shape to match the needs of the detection zone shape. |
| ateSr | 34.5 mm | Antenna conductor material closest edge to RFAM outside edge on |
| | | right hand side. Antenna may not be placed uniformly in RFAM |
| | | block (antenna including substrate 1 mm wide in this orientation). |
| ateSl | 34.5 mm | Antenna conductor material closest edge to RFAM outside edge on |
| | | left hand side. Antenna may not be placed uniformly in RFAM block |
| | | (antenna including substrate 1 mm wide in this orientation). |
| atS | 1 mm | Width of antenna. The dimension is to the edge of the printed |
| | | meandering antenna rather than the edge of the substrate. However |
| | | the difference is negligible in this case. |
| doaS | >=30 mm | Depth of antenna from RFAM base in to control RF ingress/egress |
| | | from base surface. |
| radEdgeSr | >=35 mm | Distance to edge of RFAM from closest point on the printed |
| | | meandering antenna material to this RFAM edge. Note antenna |
| | | including substrate is lmm wide in this view. The dimension is to the |
| | | edge of the printed meandering antenna rather than the edge of the |
| | | substrate. However the difference is negligible in this case. |
| rfamdS | 33 mm | This depth indicates the point at which the radius radEdgeSr meets |
| | | the sides of the RFAM block. |
| rfamDFS | 65.5 mm | Distance from base to flat surface on top of RFAM. |
| radWS | 26° | Width of segment of radius at radS. |
| slAngSl | 23° | Angle of slope from flat top right side. |
| slAngSr | 23° | Angle of slope from flat top left side. |
| radS | 29 mm | Depth of RFAM from closest edge of antenna conductor material to |
| | | centre of recessed circular area. |
| wsS | 22.5 | Overall width of slope plus centre area. |
| esSl | 10 mm | Length of edge sloping from flat top of RFAM to edge of centre |
| | | recessed flat area on left side. |
| esSr | 10 mm | Length of edge sloping from flat top of RFAM to edge of centre |
| | | recessed flat area on right side. |
| lS1 | 1.5 mm | Length of flat area seen from the left. |
| lS2 | 1.5 mm | Length of flat area seen from the right. |

Printed meandering antennas as identified in the preceding table are suitable for embodiments herein. Other antenna configurations that may be deployed in embodiments include (but are not limited to): microstrip patch, dipole, Yagi, and aperture antennas. Each kind of antenna has its own particular set of characteristics, and antenna arrangements of the kind described here would need to be adapted to the respective characteristics.

Dimensions in the above tables, which can be tuned to vary the sensitivity of a respective location sensor (for example, which may be required if the power of the transmitter is varied) for a determined detection zone are:

| FIG. 5c/5d | FIG. 5a/5b |
|---|---|
| radS | radF |
| wsS | wsF |
| slAngSr | slAngFl |
| slAngSl | slAngFr |
| esSl | esFl |
| esSr | esFr |
| lSl | lFl |
| lSr | lFr |

Due to the design of the shrouded antenna arrangement 500 and the reciprocal nature of antennas, return signals from mobile devices within a respective detection zone of a location sensor should to powerful enough to reach the antenna 505. In addition, any signal having a sufficient energy to penetrate the RFAM from any other direction may also reach the antenna (although additional RFAM or other materials/shielding may be deployed to reduce or eliminate receipt of such signals). However, such other signals (that is, those emanating from locations other than from within the detection zone) will not contain the identity of the location sensor and so can be discarded.

The RFAM shroud according to embodiments herein may be contained within a protecting case (not shown), for example made from metal or plastics, including a window in the forward-facing direction F. Such a metal protective case if considered at design time would form part of the attenuation characteristics of the sensor further limiting or preventing signals, other than those from the direction of the detection zone, from reaching the antenna.

FIG. 6a illustrates a detection zone 600 that can be produced by a location sensor of the kind that is illustrated in FIGS. 5a and 5b. As shown, the detection zone 600 has the form of a rectangular-based pyramid on top of a rectangular cuboid, which may be produced, for example, by a ceiling-mounted location sensor with the forward-facing direction F thereof being downwardly.

The detection zone 600 is constrained both in terms of its coverage and range. In this instance, each dimension (that is, length L, width W and height H) is no more than several meters. The dimensions vary with the height of the location sensor, as follows:

| | Sensor Height H | | |
|---|---|---|---|
| Dimensions | 1 m | 2 m | 3 m |
| Length L | 2 | 2 | 2 |
| Width W | 2 | 2 | 2 |

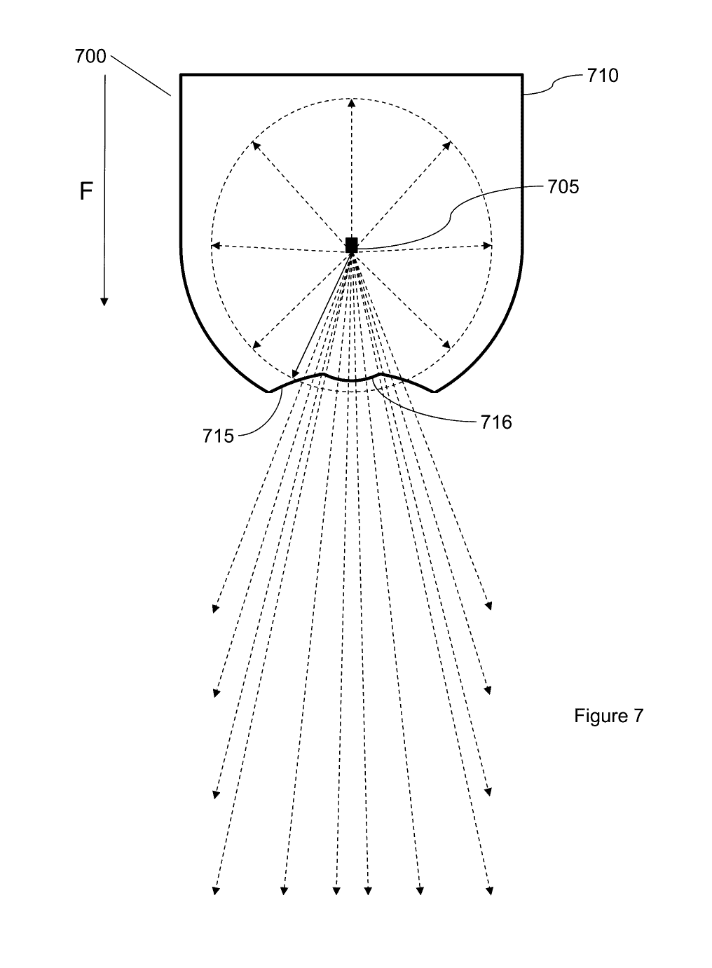

It will be noted that the size of the base and the relationship of the walls of the detection zone remain substantially constant even though the height of the sensor may vary. This is due to the geometry of the shroud, the behaviour of which will be described in more detail with reference to FIG. 7.

Relative to known kinds of antenna arrangement that are typically associated with Bluetooth and Wi-Fi hot spots, the radiated field that forms the detection zone has a well-defined shape, relatively sharp edges and a constrained range, in a generally regular form.

A further detection zone is illustrated in FIG. 6b, which shows a relatively small zone (LWH; 300×600×300 mm) and, close to, flat sides. The detection zone can be shrunk even further so that the detection can only occur when a mobile device is physically touching the respective RFAM shroud, effectively providing near field communications (NFC).

The manner with which the shrouded antenna arrangement 500 can produce a detection zone of the kind that is illustrated in FIG. 6a will now be described with reference to FIG. 7. In FIG. 7, a shrouded antenna arrangement 700 comprises an antenna 705 encased in an RFAM shroud 710. The shroud is similar in form to the shroud 510 in FIGS. 5c and 5d. The RFAM shroud 710 may be engineered from a block of RFAM. The RFAM shroud 710 has a thickness profile (that is, distance from the antenna) that varies around the antenna 705, with a reduced thickness in a generally forward direction F. The surface or face 715 of the shroud in the forward direction F has a generally concave profile, with a relatively small convex portion 716 at the centre of the concave leading face 715.

Arrows depicted in FIG. 7 indicate (in two dimensions) the coverage and range of wave front vectors emitted in various directions by the antenna 705. In all directions other than in the generally forward direction F, the radiated field is shown not to be powerful enough to pass through the RFAM shroud 710. In other words, the radiated field is attenuated in all directions other than in a generally forward direction F. Just within the periphery of the concave region 715, the relative thickness of the RFAM decreases sufficiently that a radiated field, albeit significantly attenuated, can pass through the RFAM shroud 710. The power of the radiated field increases progressively towards the centre of the concave region 715—depicted by progressively longer arrows—until the beginning of the relatively small convex portion 716. The portion of the leading face, from just inside the periphery of the convex region 715 until the beginning of the relatively small convex portion 716 defines the effective coverage of the detection zone, which in this example provides a relatively flat-sided detection zone. Across the relatively small convex portion 716, which has a radius of curvature with a centre at or near to the antenna 705, the relative thickness of the RFAM remains constant and the radiated wavefront is attenuated to produce a relatively flat distal boundary, thereby effectively defining the range of the detection zone.

It will be appreciated that the outer convex region and the inner concave region of the shroud together form a radiated field pattern into a detection zone. Accordingly, the combination of outer convex region and the inner concave region act like a lens to shape the radiated field. Accordingly, the coverage and range of the detection zone may be changed by changing the configuration, such as the diameter of the two regions and thickness profile across the regions.

In effect, the strength of the RF energy leaving the RFAM block is determined by the attenuation properties of the RFAM per unit length and the distance the RF energy has to travel through the RFAM. Therefore, the geometry of the RFAM block and the properties of the RFAM can be engineered to deliver a desired shape and extent of RF pattern outside of the RFAM block. The field is shown to terminate at the end of the illustrative arrows, at which point the field strength is at a low enough level that a typical mobile device can no longer detect the presence of the sensor (that is, at or below the cut-off point). In practice, an exemplary cut-off point may be <−70 dB, for example −71 db, −82 db, −93 db, etc. although the level may be adjusted according to the sensitivity of a typical mobile device.

A benefit of embodiments of the invention is that a shroud may be designed to have a configuration and/or surface profile that matches a resulting detection zone to a required space or region within an operating environment. Alternatively, a number of standard shrouds may be designed to provide a range of different, pre-determined forms of detection zone, and the shroud that most suits a desired or appropriate operating region may be selected.

The embodiments of a shrouded antenna arrangement herein, although quite different is outward appearance, share in common the feature that the antenna is surrounded or immersed by RFAM so that a radiated field is attenuated in all directions. The attenuation is higher in unwanted directions and lower in a forward direction, in order that a constrained detection zone may be generated, within which a mobile device may be detected, tracked and/or communicated with.

Embodiments of the invention enable the determination of the location of a mobile device (and a user holding or carrying it) to within an accuracy of a few tens of centimetres, even within an obstructed environment. This accuracy figure includes a fade margin for variable environmental conditions that may be encountered in some cases. Advantages of embodiments of the invention include providing the ability to monitor the movement of devices in small and large spaces alike, both indoors and outdoors.

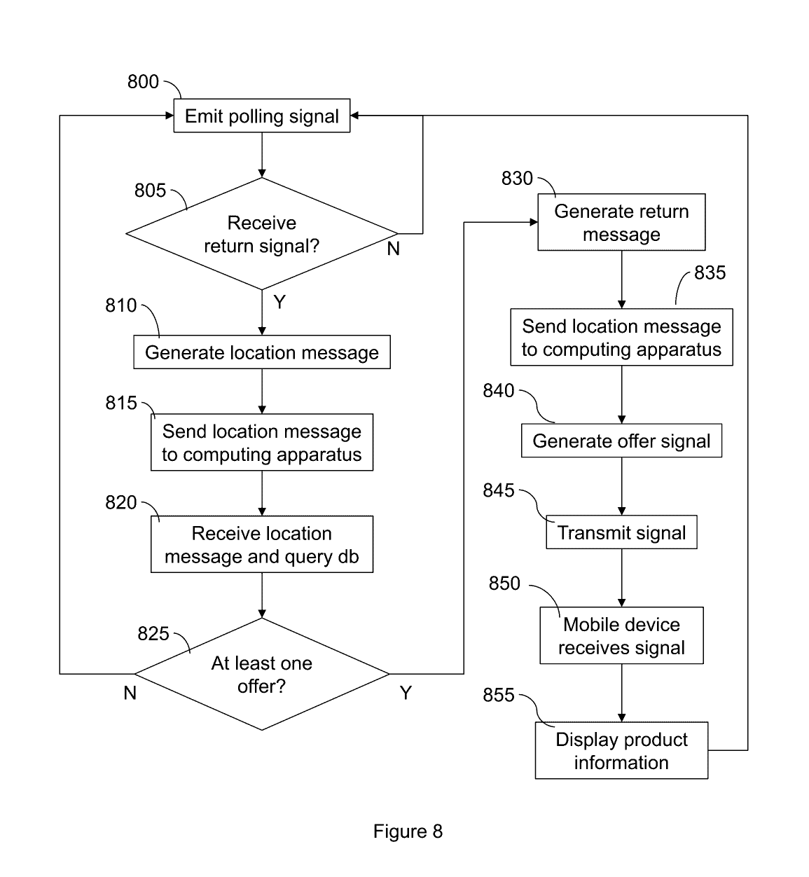

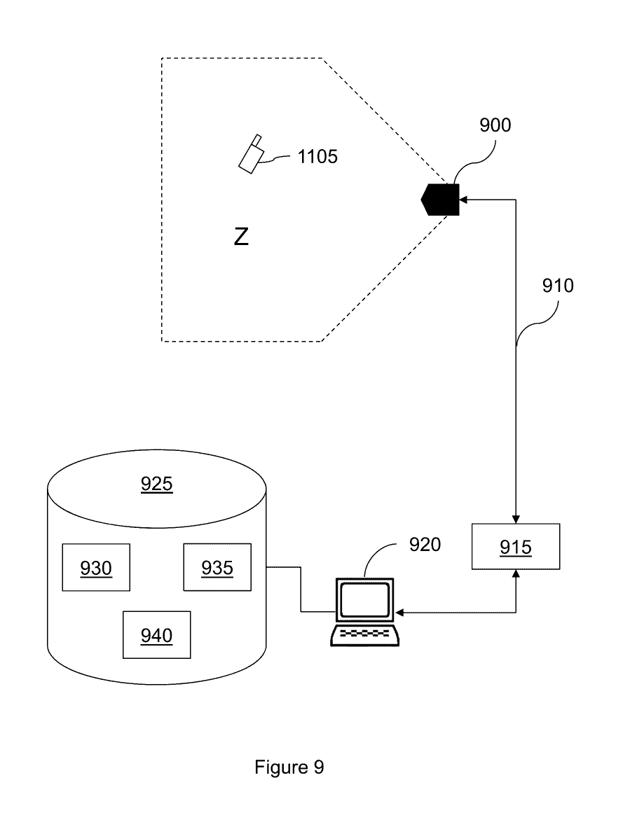

A further application of this capability will now be described with reference to the flow diagram in FIG. 8, which relates to an arrangement within a retail shopping environment as illustrated in the diagram in FIG. 9. In FIG. 9, a location sensor 900 has a detection zone Z within which is a mobile device 905. The location sensor 900 is connected via a local area network 910 and router 915 to a remote computing apparatus 920, which is connected to a retail information database 925. The database 925 contains information 930 relating to locations of detection zones (including Z) within the shopping environment, current product offers 935 and respective locations of the products 940 within the retail environment.

In a first step 800, a location sensor 900, comprising a shrouded antenna arrangement of the kind described herein, emits a polling signal including the identity of the location sensor and awaits a return signal. If, in step 805, a return signal is received (which will be from a mobile device 905 within the detection zone Z of the location sensor 900) containing the identity of the location sensor and of the mobile device, the location sensor 900 generates in a step 810 a packet of data identifying the location sensor and the identity of the mobile device and, in a next step 815, communicates the packet of data to a remote computing apparatus 920. The data packet may take any appropriate form.

In this example, the mobile device 905 is configured by control software to listen for and detect polling signals and deliver return signals in response thereto. The software may, for example, be deployed as an application program, or ‘app’, which may be downloaded from a server, such as the iOS ‘App Store’ or Android ‘Google Play’, and installed on the mobile device by the user in a known way. Other ways of deploying software programs on mobile devices, especially of the mobile devices are not mobile phones or the like, are known. For example, appropriate control software may be hard-coded (that is, written to flash memory) onto a device such as a security token.

The remote computing apparatus 920, in step 820, receives the packet of data and queries the database 925 to identify whether there are any products on offer near to the detection zone Z in which the mobile device 905 has been located. If in step 825 the database 925 identifies that there is at least one product on offer that is in the vicinity of the mobile device 905, the remote computing apparatus 920 in a step 830 generates a return data packet identifying the product or products and the identity of the mobile device 905, and transmits the packet in step 835 to the location sensor 900. The location sensor 900 then in step 840 generates a signal containing the offer information and identifying the mobile device 905, and transmits the same in step 845. The mobile device 905 receives the signal in step 850, identifies that the signal is intended for that mobile device 905, and notifies the use of the offers and/indicates the whereabouts of the product(s) relative to the location of the user, for example by generating an audible alarm and/or by displaying the offer information on a display screen of the mobile device in step 855.

An enhancement to the foregoing example comprises the database 925 (or, indeed, a further database) containing additional information pertaining to the user's purchasing preferences, with a link to the identity of the user's mobile device, whereby the return packet could be refined to contain only information relating to products on offer that the user is known to have purchased in the past or to have an interest in receiving information on. Other ways of selecting and/or filtering return data could be deployed, based on shopping preferences and other data known about the user.

The process described with reference to FIG. 9 may be performed in addition to the process that was described with reference to FIG. 4.

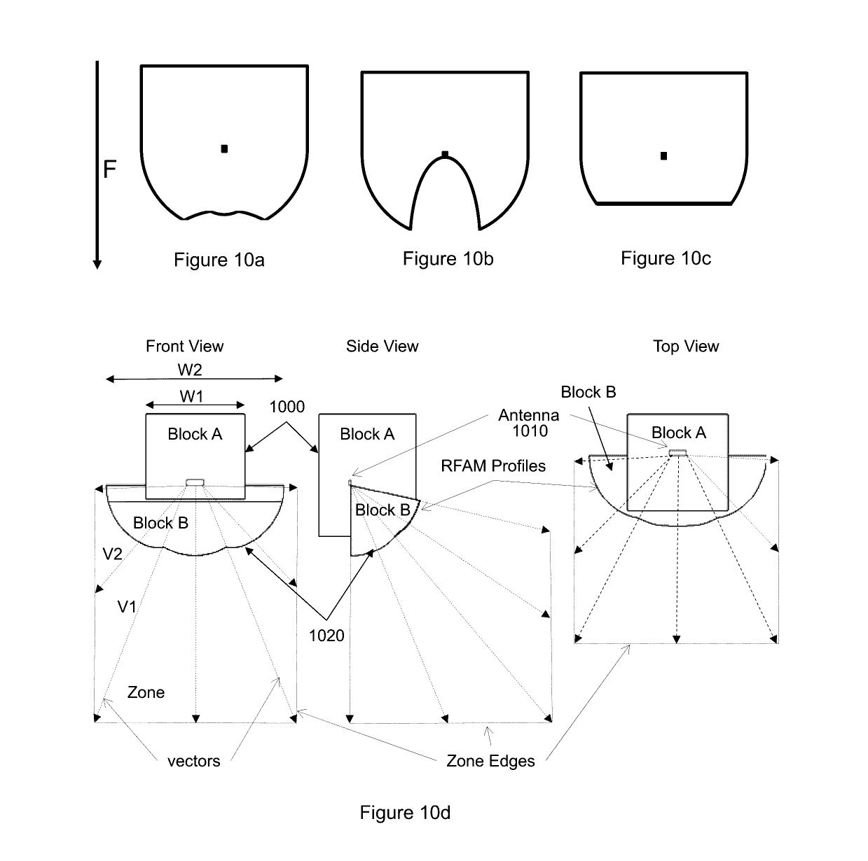

FIG. 10a for convenience reproduces the shrouded antenna arrangement of FIG. 7. FIGS. 10b and 10d illustrate alternative forms of shroud. FIG. 10b illustrates an RFAM shroud in which the RFAM has been profiled to have little or no coverage of the antenna in the forwards direction F. This enables the range of the respective detection zone to be increased for a given antenna output power. FIG. 10c illustrates an RFAM shroud in which the leading surface of the shroud is flat. This arrangement provides a detection zone having a convex far boundary, with the centre-line of the antenna's beam coinciding with the furthest extreme of the detection zone. FIG. 10d illustrates three orthogonal views of an RFAM shroud producing a detection zone shape similar to FIG. 6b.

FIG. 10d represents an RFAM shrouded antenna system similar to the other arrangements herein, that has been minimized in terms of size, cost and weight. The shrouded antenna system comprises a composite shroud 1000, comprising two functional blocks of RFAM: block A and block B. Any other appropriate number of blocks may be deployed in other examples. Block A has a generally cuboidal form, with (as best shown in the side view) a portion cut away to accommodate block B. Block B has the general form of an ovoid segment. The width W2 of block B is greater than the width W1 of block A (as is best illustrated in the front and top views). The ovoid segment of block A comprises two planar surfaces (that is, sides), joined along one edge and subtending an angle therebetween of less than 90 degrees, and an outer, leading surface 1020. A midpoint along the joined edge of block B is adjacent to or near to an antenna 1010 within the shroud 1000. As illustrated, the detection zone is delimited by zone edges forming a boundary, which is spaced apart from the shrouded antenna arrangement by a desired distance. Beyond the detection zone that is, the RF field strength emanating from the antenna (within the RFAM shroud) is attenuated to below a desired cut-off point of −70 db. Other cut-off points (that is, higher or lower) may be implemented by modifying, for example, the thickness and/or absorbency of the RFAM material that forms block A and/or block B.

As in FIG. 7, arrows in FIG. 10d illustrate wave front vectors, each representing one small part of an RF wave passing through the RFAM and continuing external of the RFAM to a point on a zone edge. As can be seen, the leading surface 1020 of block B is appropriately profiled to provide a generally cuboidal detection zone, with relatively flat edges, in which a top surface of the cuboid and a rear surface subtend an angle which is similar to the angle subtended by the joined surfaces of the ovoid segment that forms block B. The depicted length of each wave front vector corresponds with a desired distance from the antenna to a respective point on the zone edge. A distance from the antenna to a point at which a wave front vector emanating from the antenna exits the RFAM represents the depth and/or degree of absorbency of RFAM that is required to attenuate the respective wave front such that its ambient attenuation diminishes to the desired cut-off point at the zone edge. In effect, the thickness and/or absorbency of the RFAM along each vector defines the range of the respective wave front, and, accordingly, the location of the respective zone edge. Many such vectors can therefore be realised that define a depth of RFAM, and more generally an overall corresponding absorption and/or surface profile of the shroud, to produce a desired detection zone having appropriate zone edges.

It will be appreciated, for example from FIG. 7 and FIG. 10d at least, that there is a generally inverse relationship between a degree of thickness and/or absorbency of RFAM and a desired zone edge distance from the antenna. For instance, a vector V1, ending in a relatively distant corner of the detection zone, is relatively longer than a vector V2, which is along a nearby edge of the detection zone; and, accordingly, a thickness of RFAM through which vector V1 travels is shown to be relatively less than a thickness of RFAM through which vector V2 travels. In essence, a relatively more distant zone edge requires relatively less absorption from a respective RFAM shroud.

A surface profile of the RFAM can thus be formulated according to this or a similar inverse relationship to form all manner of different shapes of detection zone. The surface profile of RFAM, in order to create even complex 3-dimensional detection zone shapes, can therefore be formulated with relative ease. As will be appreciated, in the absence of any significant wave reflections (for instance, those that may otherwise be formed at an inner surface of a known kind of shroud or horn), the modelling of such zone shapes, and the provision of respective RFAM profiles, becomes relatively more straightforward. The modelling also takes into account that the antenna does not necessarily produce a perfectly circular or even a regularly-shaped radiated field. In practice, an actual field shape that is produced by an antenna may be determined by experimentation and measurement. Then, the actual field shape may be introduced into a model used to produce a correct RFAM absorption profile around a specific antenna.

With reference again to FIG. 10d, block A generally provides for mechanical handling and attenuation of unwanted outgoing and incoming RF waves, and is not primarily involved in forming the detection zone. Unwanted outgoing RF waves (that is, waves created by the internal antenna but propagating away from the detection zone) originating from the internal (to RFAM shroud) antenna are attenuated to below the cut-off for typical wireless receivers before these waves exit the RFAM shroud. Therefore devices external of the RFAM shroud (including other RFAM shrouded antennas) will not detect the presence of the RFAM shrouded antenna, even at very close proximities (for example, 1 mm between adjacent block A surfaces) in most cases. Therefore detection zones created by RFAM shrouded antennas as described herein can be arranged to be in very close proximity to one another without interference, such that, for example, RFAM shrouds can be implemented in a dense matrix of very small detection zones if required.

Similarly, Block A attenuates unwanted wave energy originating from typical wireless sources external to but penetrating the RFAM shroud. Waves approaching the internal antenna 1010 through the detection zone boundaries are least affected by the RFAM attenuation properties and the antenna internal to the RFAM shroud is only reached by external waves of sufficient energy that propagate from or through the designated detection zone.

Generally, waves emitted by the internal antenna 1010 and passing into Block B do not contain significant reflected wave components originating from the internal antenna or non-reflected or reflected wave components originating from external sources as previously described.

In general, a composite RFAM shroud may be compiled from plural RFAM components having varying wave attenuation properties that are chosen to suit the application. The performance of the RFAM may or may not be linear in terms of attenuation per mm, depending on the material that is selected, and such RFAM characteristics are factored into any modelling and design.

According to the example in FIG. 10d, block B is seamlessly mated to block A. Therefore the dimensions of block A and the characteristics of the RFAM may be chosen to attenuate the relevant energy passing through to achieve a succinct detection zone and to accommodate other design requirements. In the example illustrated in FIG. 10d, the absorbencies of the RFAM materials that are used to form block A and block B are different. The relative absorbency of block A is higher than the relative absorbency of block B, such that radiation may pass through block B to form a detection zone but not through block A. Block B surfaces that are not mated to block A are depth and surface profiled (for example, by cutting, moulding or machining) to provide the desired attenuation (that is, depth of RFAM in the path of the wave front vector as described above) and therefore range of the wave external of the block B RFAM surface. The depth and surface profile design of block B accommodates the desired zone shape in three dimensions. How the shape of the detection zone may be determined is described above or as in the context of the two-dimensional drawing shown in FIG. 7 and then extrapolated in 3D. As described above, the resultant detection zone may be most shapes including rectangular (that is, cuboid) and the surfaces of the zone may be most shapes, including flat and even, on all sides, as depicted in FIG. 6b, or profiled in any way, for example, to fit around objects and thereby avoid reflections.

In a variant to the example illustrated in FIG. 10d, block A may be coated in an RF reflective material, such as a metal foil, to further increase the attenuation properties of the block. In effect, RFAM is still used to absorb RF wave fronts that are radiated in unwanted directions from the antenna, and the introduction of the reflective material facilitates increased absorption via a two-way trip rather than via a one-way trip in the RFAM. In this way the thickness of RFAM and therefore the overall size of the shrouded antenna arrangement may be reduced. Moreover, unwanted RF waves emanating from outside of the shroud are also blocked from reaching the antenna by the exterior surface of the reflective material. In any event, such a reflective material would typically not be applied to areas of the shroud that are responsible for forming the detection zone, due to the desire to reduce or avoid reflected wave components within the detection zone. With reference to FIG. 10d, for example, there would not be any reflective material applied to at least the leading surface 1020 of block B. Of course, reflective material may in some examples be used selectively (or in an appropriately patterned way) on a leading surface to assist in forming and/or ‘cutting out’ areas from detection zones, for example, where the detection zone would otherwise impinge upon a reflective object such as an aisle or pillar.

Many other shapes and forms of shrouded antenna arrangement are anticipated, which may provide regularly or irregularly-shaped detection zones, to suit any particular shape or configuration of operating environment. Some configurations of shroud may provide a detection zone that ‘moulds’ around certain obstructions. For example, a pillar may be quite near to (for example, in the middle of a line of sight of) where a detection zone is desired. One option would be to have two shrouded antenna arrangements—one either side of the pillar. An alternative would be to provide a single shrouded antenna arrangement which, for example, has a profiled leading layer of RFAM, which delivers regions of detection zone of greater range to either side of the pillar (for example, by using thinner regions of RFAM) and a region of detection zone having a lesser range (for example, by using a thicker layer of RFAM, causing greater attenuation) in the centre of the leading face of the shroud.

In any event, it will be appreciated that the examples herein illustrate detection zones in only two dimensions as viewed from above. It will be appreciated that all of the examples and practical embodiments deliver a three-dimensional detection zone, and that the coverage and range of the detection zone may be controlled or varied in all dimensions by, for example, varying the make-up and/or surface profile of a layer of RFAM or an RFAM shroud (or both).

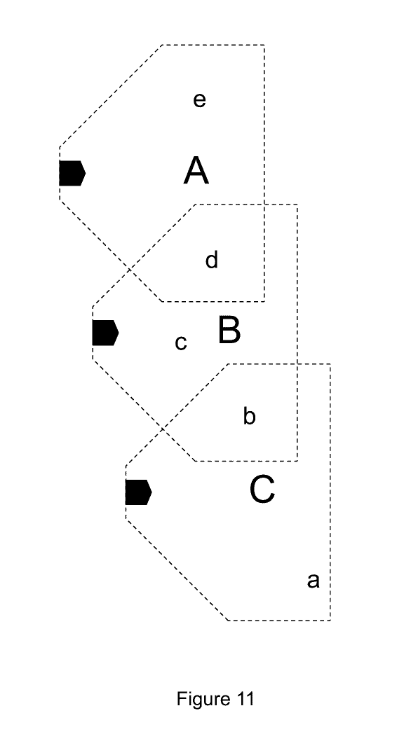

FIG. 11 illustrates a scenario in which there are overlapping detection zones. In this instance there are three overlapping detection zones, A, B and C, generated by three respective location sensors. When, for example, a mobile device is located in an overlapping region, such as region b or d as depicted in the diagram, both (or each) location sensor that contributes to the respective overlapping region may receive a return signal from the associated wireless device. In addition, where a detection occurs in an overlapping region, it is possible to conclude that the mobile device is in a much smaller region and therefore location accuracy is immediately improved. Of course, in some embodiments, a mobile device may be programmed to give priority to, and for example only return signals to, a first location sensor that is in communication with. In any event, location determination and/or location tracking of the mobile device is not impacted by the presence of overlapping detection zones. A processor receiving all of the messages, for example as the mobile device moves from locations a through e, would be able to determine the location, speed (or period of no movement) and direction of travel based on the returned signal time-stamps.

According to other embodiments, a shrouded antenna arrangement of the kind described herein may be deployed to determine the location of key or emergency personnel within an environment. Such personnel carry a mobile device that is arranged to operate as described herein, so that the location of the personnel may be tracked accurately as they move from one detection zone to another.

It will be appreciated that while embodiments of the present invention are particularly suited to use within obstructed environments, they may be deployed in any environment, both obstructed or not, indoors or outdoors, in order to provide highly granular location determination of mobile devices and their users. The granularity of location determination is a function of the relatively small size of deployed detection zones and the number of detection zones within the operating environment.

According to further embodiments, a mobile device may be an asset or security tag, which is capable of receiving signals of the kind emitted by a location sensor of the kind described herein, and provide a return signal in response thereto. Such asset or security tags may be of the RFID kind or can be any other suitable kind, for example using Bluetooth or Wi-Fi standards. Such asset or security tags may, for example, be attached to (including secreted upon) products within retail environments (for example, high value products) or equipment within hospitals, whereby any movements of the products and/or equipment may be monitored and tracked. Such movements may be legitimate or nefarious, may be reported in real time and, in the case of a nefarious act, which is for example determined because there may be no legitimate reason to move an object or equipment, any movement may reported and/or cause an alarm to be generated.

According to still further embodiments, location sensors according to embodiments herein may be used for asset tracking in production or shipping environments, and the tracking may take place within buildings or, even, across cities, countries or continents, via road, rail, sea or air. The location sensors may, for example, be deployed at intermediate travel destinations and borders, to track freight on all stages of shipping. An operating environment in this context may span cities, countries or even the entire world.

The above embodiments are to be understood as illustrative examples of the invention. Further embodiments of the invention are envisaged. For example, some location sensor embodiments may deploy RSSI location and tracking instead of, or in addition to, proximity detection based on detection zones. RSSI would enable a finer location determination when a mobile device is within a detection zone. More broadly, RSSI embodiments may be useful in large indoor or even in open outdoor environments. Indeed, in large areas, a dense arrangement comprising many location sensors of the kind described herein may be deployed.

Further, power control may be used in addition to (or instead of), for example, relying solely on configuring RFAM to obtain desired attenuation characteristics to generate a desired detection zone. For example, a reduced power applied to a transmitter be may be used to ‘tune down’ range whilst not adding additional RFAM.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. Apparatus for communicating with wireless devices, the apparatus including:
a shrouded antenna arrangement which is arranged to produce a radiated field forming a pre-determined detection zone having a boundary, spaced apart from the arrangement, outside of which the energy of the radiated field is below a pre-determined cut-off threshold, the shrouded antenna arrangement comprising an antenna within an RFAM shroud, the RFAM shroud having an absorption profile that varies around the antenna to form the detection zone.

2. Apparatus according to claim 1, wherein the absorption profile varies around the antenna in inverse relation to a distance from the antenna to the boundary to form the detection zone.

3. Apparatus according to claim 1, wherein the RFAM shroud comprises a leading surface through which the radiated field emerges to form the detection zone.

4. Apparatus according to claim 3, wherein the leading surface is shaped to provide the absorption profile.

5. Apparatus according to claim 1, wherein the absorption profile restricts the coverage and range of the radiated field in directions including in a forward direction.

6. Apparatus according to claim 1, wherein the absorption profile restricts the coverage and range of the radiated field in all directions.

7. Apparatus according to claim 1, wherein the absorption profile varies around the antenna to suppress to a lesser degree signals that are emitted in a forward direction and to suppress to a greater degree signals that are emitted in any other direction, so that the detection zone is formed generally in the forward direction.

8. Apparatus according to claim 1, wherein the absorption profile attenuates signals that are emitted in the forward direction in order to limit range of the detection zone.

9. Apparatus according to claim 1, wherein any field outside of the boundary has a power that is substantially below a reception cut-off point of any respective wireless mobile devices.

10. Apparatus according to claim 1, wherein the boundary comprises one or more relatively flat edges.

11. Apparatus according to claim 1, wherein the boundary is less than 20 meters from the antenna in all directions.

12. Apparatus according to claim 1, wherein the boundary is less than 10 meters from the antenna in all directions.

13. Apparatus according to claim 1, wherein the boundary is less than 5 meters from the antenna in all directions.

14. Apparatus according to claim 1, comprising a transmitter coupled to the shrouded antenna arrangement, the transmitter being arranged to transmit, via the antenna to the detection zone, signals including an identifier that is associated with the apparatus.

15. Apparatus according to claim 1, comprising a receiver coupled to the shrouded antenna arrangement, the receiver being arranged to receive via the antenna from the detection zone, signals including an identifier that is associated with the apparatus.

16. Apparatus according to claim 1, comprising a receiver coupled to the shrouded antenna arrangement, the receiver being arranged to receive via the antenna from the detection zone, signals including an identifier that is associated with a wireless mobile device.

17. Apparatus according to claim 1, wherein the shrouded antenna arrangement is arranged to minimise reflected wave components of wave fronts that form the pre-determined detection zone.

18. The apparatus according to claim 1 further comprising: a processor to determine from a received signal an identity of a wireless mobile device that communicated the signal, and storage for storing a record of receipt of the signal from a wireless device that is identified by the respective identity.

19. An apparatus according to claim 18, wherein the processor is arranged to determine a time at which a wireless mobile device is present in a respective detection zone of the apparatus.

20. An apparatus according to claim 18, further comprising: a plurality of said apparatuses, each apparatus having associated with it a detection zone location.

21. An apparatus according to claim 20, wherein two or more detection zones are overlapping in coverage.

22. An apparatus according to claim 20, wherein no detection zones are overlapping.

23. An apparatus according to claim 20, wherein the processor is arranged to determine a direction of movement of a wireless mobile device by inspecting times at which a wireless mobile device is determined to be present within two or more detection zones.

24. An apparatus according to claim 20, wherein the or each apparatus is arranged to emit a signal comprising an identifier of the respective apparatus.

25. An apparatus according to claim 24, which is arranged to determine the presence of a wireless mobile device within a detection zone associated with an apparatus at least in part by receipt from a wireless mobile device of a signal containing a respective identifier.

26. An apparatus according to claim 1, wherein said apparatus is a beacon.

27. A method for communicating with wireless devices, comprising:
arranging a communication apparatus in an operating environment,
wherein said apparatus includes a shrouded antenna arrangement which is arranged to produce a radiated field forming a pre-determined detection zone having a boundary, spaced apart from the arrangement, outside of which the energy of the radiated field is below a pre-determined cut-off threshold, the shrouded antenna arrangement comprising an antenna within an RFAM shroud, the RFAM shroud having an absorption profile that varies around the antenna to form the detection zone.

28. A method according to claim 27, wherein the operating environment comprises an obstructed environment, in which there are obstructions and unobstructed regions.

29. A method according to claim 28, wherein the apparatus is arranged so that each respective detection zone coincides with an unobstructed region within the obstructed environment.

30. A method for communicating with wireless devices, comprising:
arranging a communication apparatus in an operating environment,
wherein said apparatus includes a shrouded antenna arrangement which is arranged to produce a radiated field forming a pre-determined detection zone having a boundary, spaced apart from the arrangement, outside of which the energy of the radiated field is below a pre-determined cut-off threshold, the shrouded antenna arrangement comprising an antenna within an RFAM shroud, the RFAM shroud having an absorption profile that varies around the antenna to form the detection zone; and
tracking a location and/or direction of movement of a wireless mobile device communicating with said apparatus
